(19) United States
(12) Patent Application Publication
(10) Pub. No.: US 2003/0236701 A1
(43) Pub. Date: Dec. 25, 2003

(54) Method and system for affiliate tracking

(75) Inventors: Kevin Rowney, San Francisco, CA (US); Mario Karagiorgas, San Francisco, CA (US); Annie Shao, San Mateo, CA (US); Kurt Mortensen, Berkeley, CA (US); Ludovic Ferret, San Francisco, CA (US)

Correspondence Address: ROTHWELL, FIGG, ERNST & MANBECK, P.C., 1425 K STREET, N.W., SUITE 800, WASHINGTON, DC, 20005, US

(73) Assignee: NETCENTIVES, INC.

(21) Appl. No.: 09/854,721

(22) Filed: May 15, 2001

(51) Int. Cl. G06F 17/60

(52) U.S. Cl. 705/14

(57) ABSTRACT

The present invention includes a system and method for managing promotion and reward arrangements between affiliated entities, the system comprising a promotion link generator for creating a link in a site owner computer system coupled to a network, the link corresponding to a promotion in an affiliate. A reward estimator calculates and tracks any site owner points awarded to the user for completing the qualifying activity required by the promotion in the affiliate system. The reward estimator may also process site owner remuneration from the affiliate for user qualifying activity or for referrals, with or without any awards for the user. Communications means enable transfer data between the site owner and affiliate in a secure manner.

The system may be deployed with one site owner providing promotional links for a plurality of affiliates. Similarly, an affiliate may use the system to manage and track promotional links and rewards for a plurality of site owners. Furthermore, the system may be used by two or more business entities with complimentary link tracking and affiliate tracking modules. The system may use public or private networks and is scalable to meet the needs of the application.

### BACKGROUND OF INVENTION

1. Field of Invention

The invention relates to a system and method for an integrated management and tracking of commerce on a wide-access network and more particularly for the creation and management of business transactions associated with the promotion of goods and services in public and private networks.

2. Related Art

With the increase in the volume of electronic commerce conducted in electronic networks, the role and use of promotional links is becoming more important. Merchants and Internet portals use a variety of techniques to attract customers and generate traffic to their sites. These communication channels include e-mail, coupons, advertising, and HTML links in their web pages. It is important for both the merchant and the site owner (or Internet portal) to track the site visits and business generated by type of communication channel used.

Most of the current systems that track referrals as a result of advertising or links are based on arrangements recognizing the value of an advertisement or promotion depending on the number of visits to the site. Some referral tracking systems track the transactions between a merchant and the customer and use a clearinghouse to exchange information and perform accounting of the promotional relationship, (U.S. Pat. No. 5,991,740). However, there is no effective automated system and method that provides incentives to users for visiting or transacting business at affiliate sites from the perspective of the originating site and also reward the originating site owner for facilitating the transaction.

### SUMMARY OF INVENTION

The present invention includes a system and method for managing business arrangements between affiliated entities, the system comprising a promotion link generator for creating a link in a site owner computer system that is coupled to a network. The link corresponds to a promotion in an affiliate, the promotion comprising an offer to a user for award of points by the site owner in exchange for the user performing a qualifying activity in a computer system of the affiliate or an announcement of an affiliate event with or without an award to the user. A link processor decrypts and validates the user and promotion data contained in the link and redirects the user to an affiliate system capable of capturing the qualifying activity of the user. A reward estimator calculates and tracks any site owner points awarded to the user. A secure communications means enable secure transfer of data from the promotion link generator to the link processor and transfer of data from the qualifying activity selector to the reward estimator.

The system may be deployed with one site owner providing promotional links for a plurality of affiliates. Similarly, an affiliate may use the system to manage and track promotional links and rewards for a plurality of site owners. Furthermore, the system may be used by two or more entities with complimentary link tracking and affiliate tracking modules, with the user awarded the originating entity points for completing the required qualifying activities.

The qualifying activity includes activation of the link or activation of the link plus a specific transaction. The specific transaction may be a purchase of a specific merchandise, purchases totaling a specific dollar amount, subscription, purchase of a service, or membership to certain groups. The promotion channels include e-mail, banner advertising, HTML link in a web page, and off-line coupons.

The system may use a public or a private network and is scalable to meet the needs of the application.

### BRIEF DESCRIPTION OF DRAWINGS

FIG. 1A is an architectural diagram of prior art single-site award tracking systems.

FIG. 1B is an architectural diagram of prior art award system for a site owner and a merchant utilizing a clearinghouse.

FIG. 2 is a block diagram of major modules of the reward management system (RMS) in one embodiment of the present invention.

FIG. 3 is an architectural diagram of the network configuration of RMS in one embodiment of the present invention.

FIG. 4 is a flow chart of the operational steps for implementing RMS in one embodiment of the present invention.

FIG. 5A is an architectural diagram of RMS with one site owner link tracking system interacting with several affiliate tracking systems, according to one embodiment of the present invention.

FIG. 5B is an architectural diagram of RMS with one affiliate tracking system interacting with several site owner link tracking systems, according to one embodiment of the present invention.

FIG. 6 is an architectural diagram of RMS with a plurality of site owner link tracking systems interacting with a plurality of affiliate tracking systems, according to one embodiment of the present invention.

FIG. 7 is an architectural diagram of a first RMS interacting with a second RMS according to one embodiment of the present invention.

FIG. 8 is a layout of the link protocol used in communicating information between modules of RMS.

### DETAILED DESCRIPTION OF PREFERRED EMBODIMENT(S)

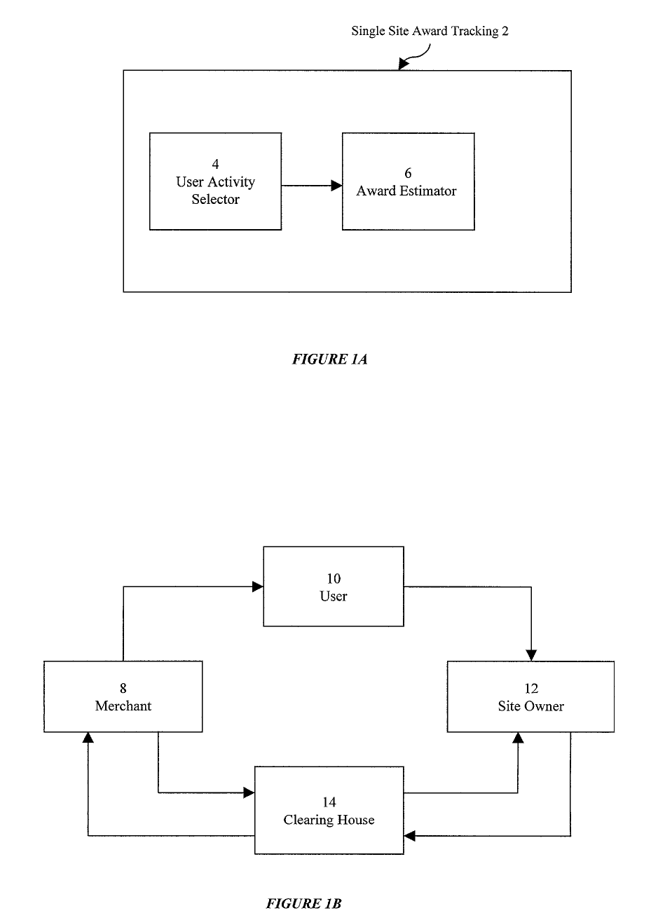

FIG. 1A is an architectural diagram of prior art single-site award tracking systems 2. A user activity selector 4 extracts logged user activity such as logging onto a web site, making a purchase, registering as a member, or entering a contest depending on what a web site use as the basis to award points. These extracted activities are used as input to an award estimator 6 which then award points to users who qualify for the award program at the web site.

FIG. 1B is an architectural diagram of prior art award system for a site owner and a merchant utilizing a clearinghouse. A merchant 8 generates a promotion to sell goods and or services and forwards the promotion to a clearinghouse 14. The clearinghouse 14 communicates the promotion to all site owners 12 qualified or authorized to display the promotion with a link in their respective web sites. A user 10, using a device to access the site owner 12 web site or accessing e-mail, clicks on the link. The user 10 is transferred to the merchant's web site and the identification (ID) of the user 10 is recorded in the user's browser using a cookie or other similar means. If the user 10 accepts the offer in the promotion, a sales commission is calculated for the site owner 12.

### Definitions

The following definitions apply to the rest of the specifications:

Affiliate is an entity with a network accessible computer system that contains offerings of goods, services, or affinity referred to in promotions. (Note that an entity may both be a site owner and an affiliate.) An affiliate may pay the site owner remuneration or commissions for users activating a link and or performing a qualifying transaction.

Business ID is the unique identification of either the site owner or the affiliate.

Campaign ID is the identifier associated with each batch of generated links or coupons.

Channel type is the communication channel used to make the promotion accessible to users. The usual channel types are hypertext markup language (HTML) formatted e-mail, off-line coupons, banner advertising (ad) or link in a picture, HTML link in a web page, and other forms of links in electronic and non-electronic promotions.

Click-through or link activation is a user action that activates a link and transfer to a network accessible computer system. Click-through includes clicking a mouse on a link and other equivalent user activity such as voice commands, keyboard actions, pressure on contact sensitive screens, or any equivalent activity or simulation of the activity using hardware or software.

Destination uniform resources locator (URL) or destination URL is the network address or a symbol translatable to the network address of a computer system where a user is transferred upon performing a click-through.

Expiration date is the date after which the link or coupon is not valid anymore.

Link ID is a combination of keys and identifiers that makes a link unique. In one embodiment, the Link ID consists of the Campaign ID, Serial Number, and Business ID.

Link type is the characterization of user activity needed to qualify for an award, with the two usual link types being click-through only and click-through with a specific transaction. A click-through only user activity is one where a user is rewarded immediately upon activating a link. A click-through plus a specific transaction is one where the user activates the link and makes the specific transaction, such as making a purchase or engaging in a service contract or registering as a member of a group, before getting a reward.

Points refer to the quantity of the award offered by the site owner to users activating the promotion link. Points may represent some form of a site owner's currency. Note however that RMS does not require an award to the user. RMS includes functionality to process site owner and affiliate business arrangement for referrals, such as commissions, whether or not the user is awarded points.

Promotion ID is the unique identification associated with a promotion.

Serial Number is a unique number associated with a link or a coupon.

Site owner is an entity with a network accessible computer system that presents promotions containing links that transfer the user to a different place in the same computer system or to another entity's computer system coupled to the network. A site owner may receive remuneration or commissions for users activating a link and or performing a qualifying transaction in the affiliate site.

Signature is a code developed from a set of data using an algorithm and is used for authentication of recipients or senders of information.

Target type is a code designating whether the user is specifically targeted or is an anonymous user.

User ID is any string representing the user and may be an e-mail ID.

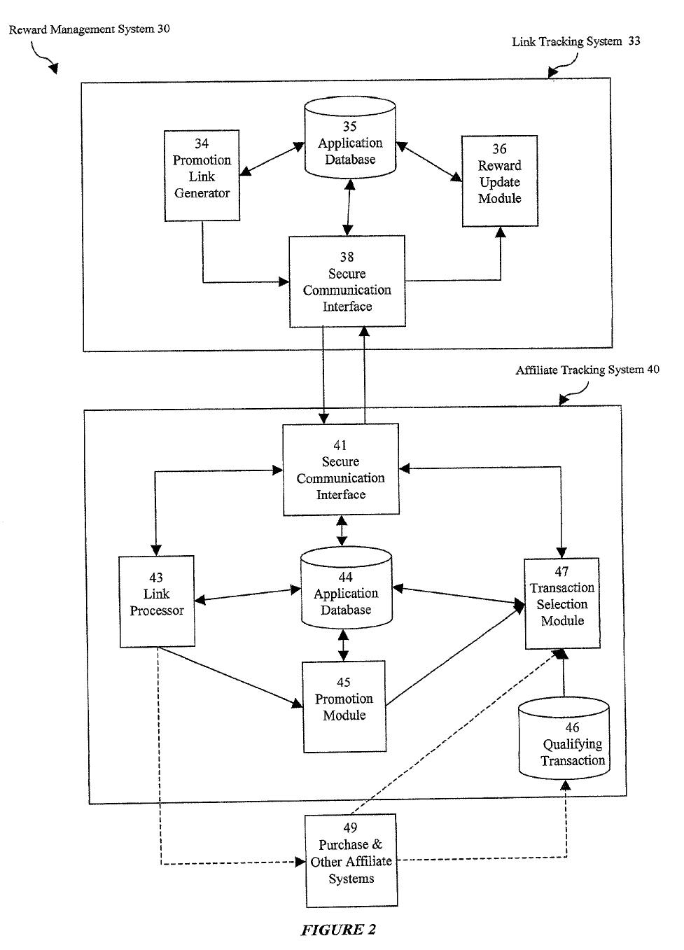

FIG. 2 is an architectural diagram of the link tracking and affiliate tracking systems in one embodiment of the reward management system (RMS). There are two major components of RMS 30, namely, the Link Tracking System 33 and the Affiliate Tracking System 40. The Link Tracking System 33 comprises a Promotion Link Generator 34, a Reward Update Module 36, and a Secure Communications Interface 38.

The Promotion Link Generator 34 is used to create promotions and links for the different channels types such as (HTML) formatted e-mail, off-line coupons, banner ads or link in a picture, HTML links in a web page, and other forms of links in electronic and non-electronic promotions. The links include the destination URL for each promotion as well as additional information which may be clear text in a secure network and/or encrypted data and/or data signed with a key certificate. The links are incorporated into the e-mail, banner ad, HTML page, or printed onto coupons. For an off-line coupon sent to a user, the Promotion Link Generator 34 provides means for the user to enter data printed on the coupon including destination URL and coupon value consisting of campaign ID, serial number, and signature. Upon successful entry of coupon data, the Promotion Link Generator 34 activates the link.

The Reward Update Module 36 handles the awarding of site owner points to the user for a qualifying user activity at the affiliate site and calculates the remuneration of the site owner. The Secure Communications Interface 38 handle the secure data exchange between the Link Tracking System 33 and the Affiliate Tracking System 40. The Application Database 35 contains link information, compensation agreements with affiliates that have business arrangement with the site owner, user ID cross reference, and installation options for the Link Tracking System 33.

Referring to FIG. 2, the major components of the Affiliate Tracking System 40 include the Secure Communication Interface 41, the Link Processor 43, the Promotion Module 45, and the Transaction Selection Module 47. Affiliate Tracking System 40 includes the Qualifying Transaction table 46 and the Application Database 44. The Link Processor 43 decrypts and validates the link data. If the link data is invalid, the user is transferred to an error page or returned to the link origination site for error processing. If the link type is a click-through only promotion, identifying information such as user ID is extracted from the link data, site owner award points, if any, is appended and the information is transmitted to the Link Tracking System 33 where appropriate award processing is performed. If the link type is a click-through plus a specific transaction, then the Link Processor 43 places a user tag in the user's system and the user is directed to the Purchase and Other Affiliate Systems 49 where the user may perform the specific qualifying transaction activity. The Purchase and Other Affiliate Systems 49 may either directly provide the qualifying transaction to the Transaction Selection Module 47 or store the qualifying transaction in the Qualifying Transaction Table 46. To address client security requirements, the client may implement RMS capabilities to restrict one user per targeted link or one link per user. For example, only the specific targeted user may use an e-mail targeted link and the user may only use the e-mail targeted link once.

Depending on the installation option, the Transaction Selection Module 47 may either capture the qualifying transaction immediately or periodically select all qualifying transactions from the Qualifying Transaction Table 46. A user performing a click-through or a click-through plus a qualifying transaction associated with the promotion is tracked by Link Tracking System 33. The number of points earned by a user and the qualifying transactions are stored in the Qualifying Transaction Table 46. The Transaction Selection Module 47 sends the qualifying transactions to the Secure Communication Interface 41. The Secure Communication Interface 41 encrypts and transmits collections of data in a secure manner to the complimentary Secure Communication Interface 38 in the Link Tracking System 33.

Still referring to FIG. 2, the Promotion Module 45 is designed to present a variety of other promotions to the user upon being transferred to the Affiliate Tracking System 40. Examples of different promotions are pop-up promotions and basket-analysis promotions. Pop-up promotions encourage the user to take advantage of earning additional site owner points if the user completes another qualifying transaction. Basket-analysis promotions provide a variety of promotional alternatives, including an award for purchase of a specific item, an award for activating a link from the site owner a predetermined number of times, an award for being a first time visitor or purchaser, an award regardless of item purchased, an award based the dollar level of purchases, and an award for referring someone to the site. The Promotion Module 45 may also be used to create affiliate promotions corresponding to the promotions tracked in the Link Tracking System 33. The promotion ID's of promotions created in the Affiliate Tracking System 40 are communicated to the Link Tracking System 33. (The usual process is for the Promotion Link Generator 34 to create the promotions for an affiliate and to communicate the promotion ID's to the Affiliate Tracking System 40.) The Application Database 44 contains link information about site owners that have business arrangement with the affiliate, locations of supporting files, user ID cross reference, and installation options for Affiliate Tracking System 40.

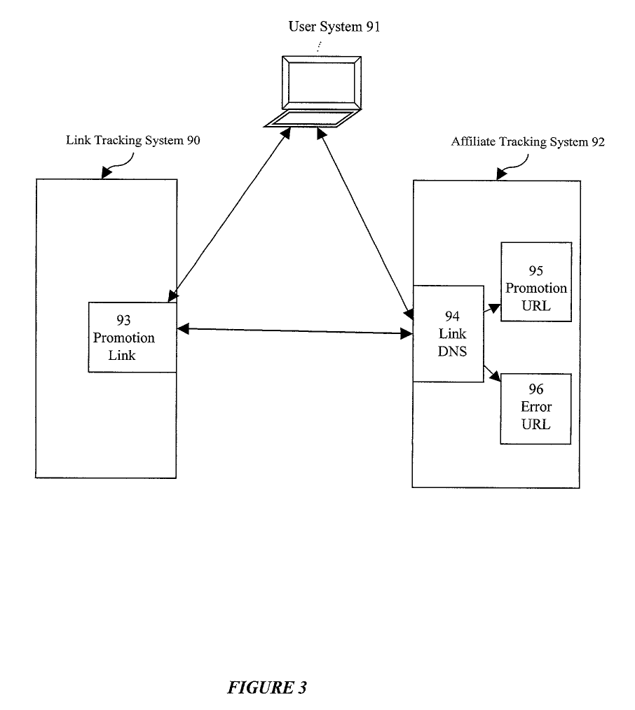

FIG. 3 is an architectural diagram of the network configuration of RMS in one embodiment of the present invention. A user activating the promotion link 93 is routed to the Link Domain Name Server (DNS) or Link DNS 94, a lower level domain name server entry in the affiliate's network domain set aside by the affiliate to be used exclusively by the Affiliate Tracking System 92. Affiliate Tracking System 92 decrypts and edits the link data, redirecting the user to the promotion URL 95 if the link data is valid or to the error URL 96 if the link data is invalid. Similarly, if the promotion link is embedded in an e-mail sent to the user system 91, the user is routed to the Link DSN 94 and follows the same processing as previously described. For example, consider a user activating a special summer promotion link for Internet merchant CDSeller in the site owner PORTAL. Upon activating the link, the user is routed to the network address of:

http:\\www.clickPortal.CDSeller.com:.... (additional link info).

If the link data is valid, the user is redirected to the promotion URL:

http:\\www.CDSeller.com/special/summer/html.

If the link data is invalid, the user is redirected to the error URL:

http:\\www.CDSeller.com/special/error/html.

Still referring to FIG. 3, some affiliates do not want a network direct access to an affiliate system. An alternate embodiment includes a proxy server placed between the Link Tracking System 90 and Affiliate Tracking System 92 in order to address this security requirement of the affiliate.

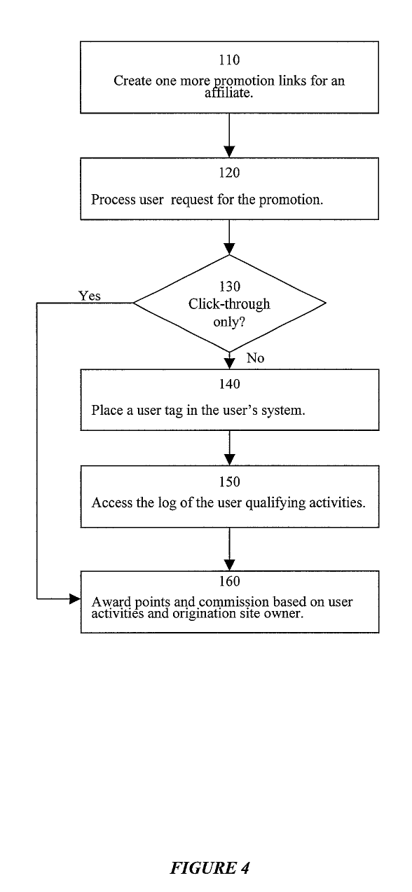

FIG. 4 is a flow chart of the operational steps for implementing RMS in one embodiment of the present invention. Initially, one or more promotion links to the affiliate are created 110. These promotions, identified by a unique promotion ID, may be created in the Link Tracking System or in the Affiliate Tracking System. If the promotion is created in the Affiliate Tracking System, the promotion ID's are made available to the site owner Link Tracking System for use in creation of promotion links. The links include the destination URL, link ID, link type, target type, promotion ID, and other link information. In one embodiment, the link ID consists of the campaign ID, serial number, and business ID. The other link information may include coupon value, channel type, coupon signature length, promotion expiration date, purchase window, and e-mail ID.

Referring still to FIG. 4, when a user activates the link, RMS is invoked and the user is transferred to the destination URL whereupon RMS processes the user request for the promotion 120 which includes decryption of the data. If the promotion link type is a click-through only 130, then processing proceeds to awarding of site owner points, if any, and calculation of originating site owner remuneration. Otherwise, a user tag in placed in the user's system 140 and the user is redirected to the promotion URL. In one embodiment, the user tag is a cookie placed in the user's browser. RMS accesses the log of user qualifying activities 150. If the promotion link type is a click-through plus a specific transaction, RMS either immediately accesses the qualifying transaction or collects all qualifying transactions at periodic time intervals. The qualifying transaction may be completed by the user during the same visit or at a later visit. RMS may associate the qualifying transaction to the earliest user visit from the originating site owner for the particular promotion, or use some criteria selected for the application.

The last step of FIG. 4 is the awarding of points and calculation of site owner remuneration 160 based on user completion of qualifying activities. The award points are specific to the site owner where the user originated and may take the form of any award or form of currency of the site owner. The remuneration or commission of the site owner is also calculated and credited to the site owner's account. Note however that RMS does not require an award to the user. RMS includes functionality to process site owner and affiliate business arrangement for referrals, such as commissions, whether or not the user is awarded points.

For example, site owner PORTAL has a promotion indicating a visit at CDSeller's web site will earn the user 100 PORTAL points. Upon activating the link, the user earns the 100 points PORTAL points and PORTAL is entitled to the prearranged compensation from CDSeller. Another example is the user activating a promotion where the user will earn 200 PORTAL points upon purchase of book A at BookSeller's web site. Upon activating the link, a record of the user is immediately logged in RMS and a user tag, normally a cookie, is placed in the user's browser. When the user buys book A, BookSeller's purchase system records the purchase in a table accessible to RMS. This qualifying transaction triggers an award of 200 PORTAL points to the user and calculation of remuneration for PORTAL from BookSeller.

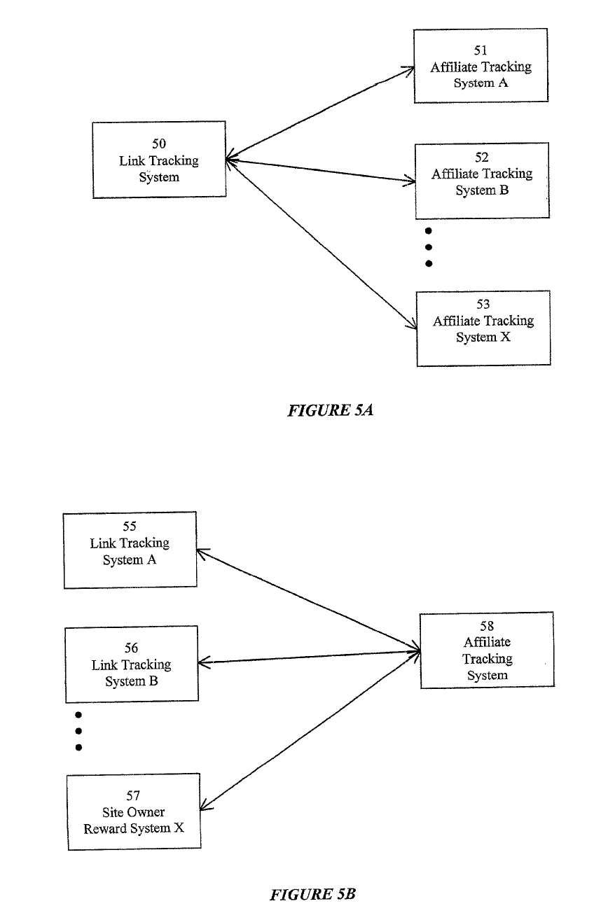

FIG. 5A is an architectural diagram of RMS with one link tracking system interacting with several affiliates tracking systems, according to one embodiment of the present invention. Link Tracking System 50 is coupled to a plurality of Affiliate Tracking System A 51, Affiliate Tracking System B 52 . . . , and Affiliate Tracking System X 53. Through the use of the application database, Link Tracking System 50 tracks individual affiliate's link DNS's, site owner business arrangements, promotions, and points awarded to users per promotion. For example, if site owner PORTAL has affiliate arrangements with CDSeller, OnlineLoans, and Egroup, the link DNS's in the application database of the Link Tracking System would include:

http:\\www.clickPortal.CDSeller.com:.... (additional link info),

http:\\www.clickPortal.OnlineLoans.com:.... (additional link info).

http:\\www.clickPortal.EGroup.com:.... (additional link info).

FIG. 5B is an architectural diagram of RMS with one affiliate tracking interacting with several link tracking systems, according to one embodiment of the present invention. An Affiliate Tracking System 58 is coupled to Link Tracking System A 55, Link Tracking System B 56 . . . , and Link Tracking System X 57. Through the application database, Affiliate Tracking System tracks the location of individual site owner Qualifying Transaction files and network address for transmitting user purchase amounts, user earned points, user ID's, and other information related to the promotion. For example, CDSeller may have a summer promotion for purchase of merchandise worth $100 or more displayed in banner ads at site owners PORTAL1, PORTAL2, and PORTAL3. The Affiliate Tracking System 58 tracks the separate purchases of users originating from PORTAL1, PORTAL2, and PORTAL3. In addition, Link Tracking System A 55 tracks the PORTAL1 points awarded to PORTAL1 users, Link Tracking System B 56 tracks the PORTAL2 points to PORTAL2 users, and Link Tracking System X 57 tracks the PORTAL3 points to PORTAL3 users.

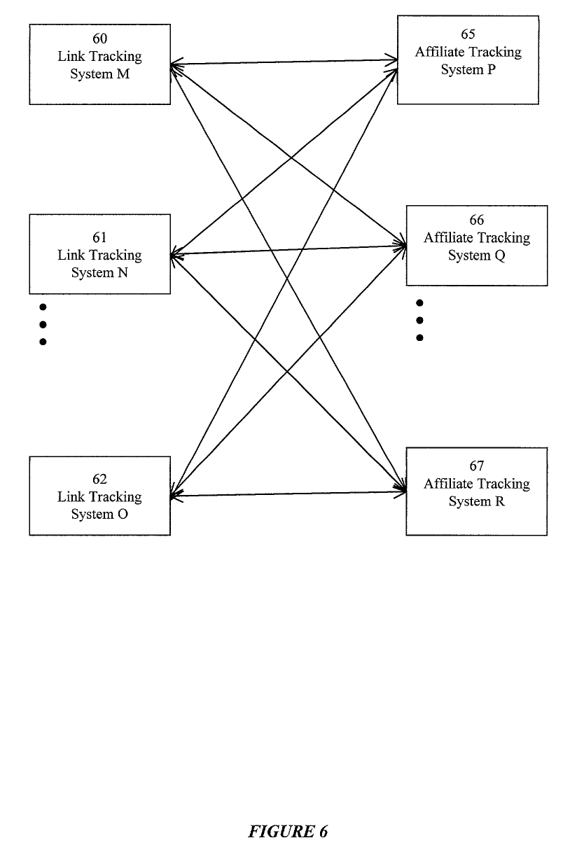

FIG. 6 is an architectural diagram of the RMS with a plurality of link tracking systems each interacting with a plurality of affiliate tracking systems and vice versa, according to one embodiment of the present invention. Link Tracking Systems M 60 tracks promotion links, awarded points, and commissions at Affiliate Tracking System P 65, Q 66 . . . , and R 67. Affiliate Tracking System P 65 tracks the click-throughs, purchases, and site owner earned points and transmit the respective data to Link Tracking System M 60, N 61 . . . , and O 62.

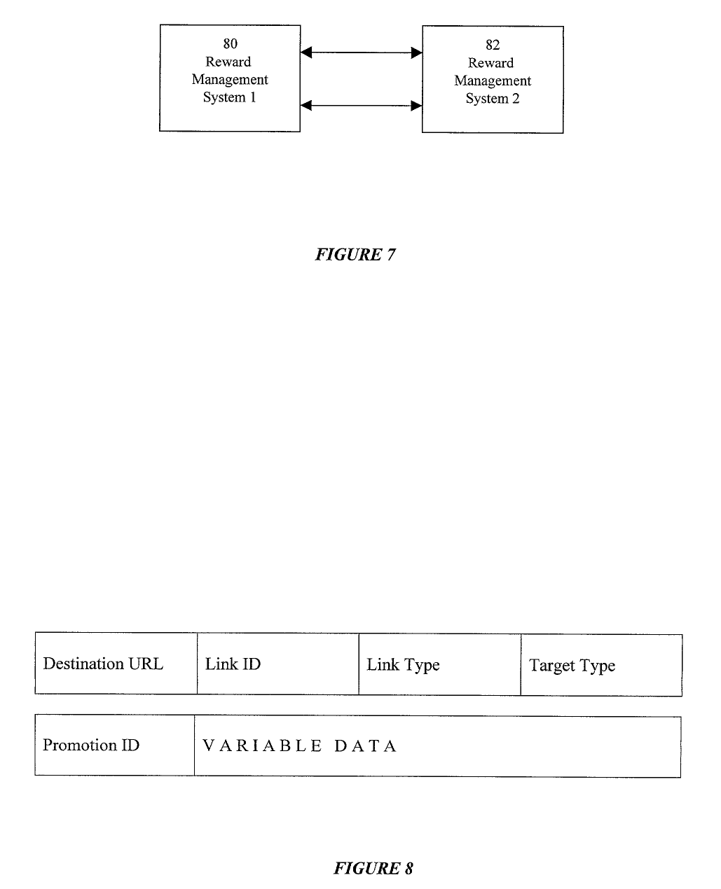

FIG. 7 is an architectural diagram of a first RMS interacting with second RMS according to one embodiment of the present invention. In this embodiment, a set consisting of a Link Tracking System and an Affiliate Tracking System combine as RMS and is installed at the first site owner location; another RMS is installed at the second site owner location. In the first site owner location, the Link Tracking System of RMS 1 80 contains promotional links for the second site owner where the Affiliate Tracking System of RMS 2 82 tracks the click-throughs, purchases, and first site owner awarded points. Conversely, the Link Tracking System of RMS 2 82 contains promotional links for the first site owner where the Affiliate Tracking System of RMS 1 80 tracks the click-throughs, qualifying transactions, and second site owner awarded points.

For example, assume the first site owner is CDSeller and the second site owner is OnlineLoans. The RMS at CDSeller may carry a promotional link for online mortgage loan processing at OnlineLoans with the user getting 100 CDSeller points if the user registers as a member of OnlineLoans. The RMS at OnlineLoans would log the qualifying user activity, the 100 CDSeller points awarded to qualified users, and transmit this information to the RMS at CDSeller. Conversely, OnlineLoans may at the same time carry a promotional link for a summer sale of CD's at CDSeller awarding 250 OnlineLoans points for a purchase of $80 or more. The RMS at CDSeller would log user purchases of CD's related to the promotion, the 250 OnlineLoans points awarded to users who bought at least $80 of CD's, and transmit these information to the RMS at OnlineLoans.

FIG. 8 is a layout of the link protocol used in communicating information between modules of RMS. The Link Tracking System communicates with the Affiliate Tracking System and one RMS communicates with another RMS using a standard protocol comprising the destination URL, RMS token, and variable data. The destination URL maybe a DNS name selected at installation time that translates to a network address. The RMS token provides RMS with sufficient identification of the link, the promotion, and codes needed to validate a user and qualify a user activity for an award of points. The RMS token comprises the link ID, link type, target type, and promotion ID. Link ID is a combination of keys and identifiers that make a link unique. In one embodiment, the link ID consists of the campaign ID, serial number, and business ID. The variable data may include coupon value, channel type, coupon signature length, promotion expiration date, purchase window, and e-mail ID. It is understood by one knowledgeable in the art that the destination URL may be any symbol that is translatable to a network address. Similarly, it is understood by one knowledgeable in the art that functionally equivalent data may be used in the RMS token and still stay within the concepts and principles of the present invention.

RMS may be implemented using Microsoft NT or Solaris operating system or other comparable operating systems. RMS is scalable and modular; it may be installed with the Link Tracking System only, with the Affiliate Tracking only, or with both major components operative. RMS may track several affiliates and or interface with several site owners concurrently. The Secure Communication Interface enables exchange of data between two sites in a secure manner utilizing encryption and digital certification techniques. RMS does not require a clearinghouse or central site for exchanging data. Installation options allows flexibility in setting the configuration of the system. The application database facilitates client customization of a particular RMS application.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks.

Other variations and embodiments are possible in light of above teachings, and it is thus intended that the scope of invention not be limited by this Detailed Description, but rather by Claims following.

What is claimed is:

1. A method of managing affiliate business arrangements, the method comprising:
creating a link in a site owner computer system coupled to a network, the link corresponding to a promotion in an affiliate, the promotion being an offer to a user for award of points by the site owner in exchange for the user performing a qualifying activity in a computer system of the affiliate;
making the promotion accessible to the user by utilizing one or more promotion channels; and
tracking of site owner points awarded to the user for completing the qualifying activity required by the promotion;
wherein the qualifying activity includes activation of the link or activation of the link plus a specific transaction, the specific transaction including purchase of a specific merchandise, purchases totaling a specific dollar amount, subscription, purchase of a service, and membership to certain groups.

2. The affiliate business arrangement management method of claim 1, wherein the link comprises a destination uniform resource locator, a token, and additional link information, the token including link ID, link type, target type, and promotion ID.

3. The affiliate business arrangement management method of claim 1, wherein the one or more promotion channels is selected from the group consisting of e-mail, banner advertising, HTML link in a web page, and off-line coupon.

4. The affiliate business arrangement management method of claim 1, wherein the network is selected from the group consisting of public networks and private networks.

5. The affiliate business arrangement management method of claim 1 further comprising awarding of site owner points to the user upon completion of the qualifying activity associated with the promotion and calculating a reward for the site owner corresponding to the qualifying activity completed by the user in response to the promotion.

6. The affiliate business arrangement management method of claim 1 wherein there is no clearinghouse server.

7. A system for managing promotional reward arrangements between affiliated entities, the system comprising:
a promotion link generator for creating a link in a site owner computer system coupled to a network, the link corresponding to a promotion in an affiliate, the promotion including an offer to a user for an award of points by the site owner in exchange for the user performing a qualifying activity in a computer system of the affiliate, and for making the promotion accessible to the user by utilizing one or more promotion channels;
a link processor for decrypting and validating user and promotion data contained in the link and for redirecting the user to an affiliate system capable of capturing the qualifying activity of the user;
a qualifying activity selector for accessing the captured qualifying activity of the user;
a reward estimator for calculating and tracking of site owner points awarded to the user for completing the qualifying activity required by the promotion; and
secure communications means for transferring data from the promotion link generator to the link processor and for transferring data from the qualifying activity selector to the reward estimator;
wherein the user, activating the link contained in the promotion, is transferred to the link processor, the link processor validating the link data and redirecting the user to an affiliate system capable of capturing the qualifying activity of the user, the qualifying activity selector accessing any captured qualifying activity of the user, and the reward estimator calculating and tracking of site owner points awarded to the user.

8. The affiliated-entities reward management system of claim 7 wherein the link comprises a destination uniform resource locator, a token, and additional link information, the token including link ID, link type, target type, and promotion ID.

9. The affiliated-entities reward management system of claim 7 wherein the destination uniform resource locator is a lower level domain name of a domain name server for the affiliate.

10. The affiliated-entities reward management system of claim 7 wherein the one or more promotion channels is selected from the group consisting of e-mail, banner advertising, HTML link in a web page, and off-line coupon.

11. The affiliated-entities reward management system of claim 7, wherein the network is selected from the group consisting of public networks and private networks.

12. The affiliated-entities reward management system of claim 7 wherein the reward estimator calculates a reward for the site owner corresponding to the qualifying activity completed by the user in response to the promotion.

13. The affiliated-entities reward management system of claim 7 wherein there is no clearinghouse server.

14. The affiliated-entities reward management system of claim 7 wherein the secure communications means comprise a proxy server providing an extra security layer prior to the user being transferred to the link processor.

15. The affiliated-entities reward management system of claim 7 wherein the promotion link generator includes capability for entry of off-line coupon information including a destination uniform resource locator, a token, and additional link information, the token including link ID, link type, target type, and promotion ID.

16. A system for managing promotion and reward arrangements between one site owner and a plurality of affiliated entities, the system comprising:
a promotion link generator for creating a plurality of links in a site owner computer system coupled to a network, each link of the plurality of links corresponding to a promotion in an affiliate of a plurality of affiliates, the promotion including an offer to users for award of points by the site owner in exchange for the users performing a corresponding qualifying activity in a computer system of the corresponding affiliate of the plurality of affiliates;
a link processor for each affiliate of the plurality of affiliates, the link processor for each affiliate capable of decrypting and validating of link data and capable of redirecting the users to the corresponding computer system of each affiliate of the plurality of affiliates, the corresponding computer system capable of capturing the corresponding qualifying activity of the users;
a qualifying activity selector for each affiliate of the plurality of affiliates accessing the corresponding captured qualifying activity of the users;
a reward estimator for calculating and tracking of site owner points awarded to the users that performed the qualifying activity required by the promotion; and
secure communications means for transferring data from the promotion generator to the link processor for each affiliate of the plurality of affiliates and for transferring data from the qualifying activity selector for each affiliate of the plurality of affiliates to the reward estimator;
wherein the users, activating a plurality of links, are transferred to the corresponding link processor, the corresponding qualifying activity selector accessing the corresponding captured qualifying activity, and the reward estimator, calculating and tracking of site owner points awarded to the corresponding users that performed the corresponding qualifying activity.

17. A system for managing promotion and reward arrangements between a plurality of site owners and one affiliate, the system comprising:
a first promotion link generator for creating a first link in a first site owner computer system coupled to a network, the first link corresponding to a first promotion in an affiliate, the first promotion including an first offer to a first user for award of points by the first site owner in exchange for the first user performing a first qualifying activity in a first computer system of the affiliate, and for making the first promotion accessible to the first user;
a second promotion link generator for creating a second link in a second site owner computer system coupled to the network, the second link corresponding to a second promotion in the affiliate, the second promotion including a second offer to a second user for award of points by the second site owner in exchange for the second user performing a second qualifying activity in a second computer system of the affiliate, and for making the second promotion accessible to the second user;
a link processor for validating link data, for redirecting the first user to the first computer system of the affiliate and for redirecting the second user to second computer system of the affiliate;
a qualifying activity selector for accessing the first qualifying activity of the first user and the second qualifying activity of the second user;
a first reward estimator for calculating and tracking of the first site owner points awarded to the first user for completing the first qualifying activity; and
a second reward estimator for calculating and tracking of the second site owner points awarded to the second user for completing the second qualifying activity;
wherein the first user and the second user, activating the first link and second link respectively, are transferred to the link processor of the affiliate, the link processor validating the link data, redirecting the first user to a first computer system of the affiliate capable of capturing the first qualifying activity and redirecting the second user to a second computer system capable of capturing the second qualifying activity, the first reward estimator calculating and tracking the first site owner points awarded to the first user, and the second reward estimator calculating and tracking of the second site owner points awarded to the second user.

18. A system for managing promotion and reward arrangements between two entities that are concurrently site owners and affiliates, the system comprising:
a first promotion link generator for creating a first link in a first entity computer system coupled to a network, the first link corresponding to a first promotion in a second entity, the first promotion including a first offer to a first user for an award of points by the first entity in exchange for the first user performing a first qualifying activity in a computer system of the second entity;
a second promotion link generator for creating a second link in a second entity computer system coupled to the network, the second link corresponding to a second promotion in the first entity, the second promotion including a second offer to a second user for an award of points by the second entity in exchange for the second user performing a second qualifying activity in a computer system of the first entity;
a first link processor for decrypting and validating link data, for redirecting the first user to the second entity system capable of capturing the first qualifying activity of the first user;
a second link processor for decrypting and validating link data, for redirecting the second user to the first entity system capable of capturing the second qualifying activity of the second user;
a first reward estimator for calculating and tracking of the first entity points awarded to the first user;
a second reward estimator for calculating and tracking of the second entity points awarded to the second user; and
a secure communications means for transferring data between the first entity computer system and the second entity computer system,
wherein the first user, activating the first link, is transferred to the first link processor, the first link processor validating the link data, redirecting the first user to the second entity system capable of capturing the first qualifying activity of the first user, and the first reward estimator, calculating and tracking of first entity points awarded to the first user; and
wherein the second user, activating the second link, is transferred to the second link processor, the second link processor validating the link data, redirecting the second user to the first entity system capable of capturing the second qualifying activity of the second user, and the second reward estimator, calculating and tracking of second entity points awarded to the second user.

19. The system for managing promotion and reward arrangements between a plurality of site owners and a plurality of affiliates of claim 18 further comprising a application database for storing a first user ID cross referenced to a second user ID, the first user ID identifying the first user in the first promotion link generator and the second user ID identifying the first user in the second promotion link generator, and for enabling the first user to be awarded points by the first entity and by the second entity without requiring the first user to sign on after the first user activating the first link.

20. A method of conducting reward management and tracking between a site owner and an affiliate, the method comprising:
offering by the site owner to a user to award site owner points to the user in exchange for the user performing a qualifying activity related to a promotion involving an affiliate;
offering by the affiliate to compensate the site owner for the user completing the qualifying activity within the conditions of the offer by the site owner provided the site owner award the site owner points to the user after completing the qualifying activity required by the promotion;
accepting by the user of the offer from the site owner by completing the qualifying activity related to the promotion involving the affiliate; and
accepting by the site owner of the offer of the affiliate by awarding site owner points to the user upon completion of the qualifying activity;
wherein the qualifying activity includes activation of a link or activation of the link plus a specific transaction, the specific transaction including purchase of a specific merchandise, purchases totaling a specific dollar amount, subscription, purchase of a service, and membership to certain groups.

21. A method for conducting promotional reward management and tracking between two entities that are concurrently site owners and affiliates, the method comprising:
offering by the first entity to a first user to award first entity points to the first user in exchange for the first user performing a first qualifying activity related to a promotion involving a second entity;
accepting by the first user of the offer from the first entity by completing the first qualifying activity related to the promotion involving the second entity;
offering by the second entity to compensate the first entity for the first user completing the first qualifying activity within the conditions of the offer by the first entity provided the first entity award the first entity points to the first user upon completing the first qualifying activity required by the promotion;
accepting by the first entity of the offer of the second entity by awarding first entity points to the first user upon completion of the first qualifying activity;
offering by the second entity to a second user to award second entity points to the second user in exchange for the second user performing a second qualifying activity related to a second promotion involving the first entity;
accepting by the second user of the offer from the second entity by completing the second qualifying activity related to the second promotion involving the first entity; and
offering by the first entity to compensate the second entity for the second user completing the second qualifying activity provided the second entity award the second entity points to the second user upon completing the second qualifying activity required by the second promotion;
accepting by the second entity of the offer of the first entity by awarding second entity points to the second user upon completion of the second qualifying activity;
wherein the first qualifying activity and second qualifying activity include activation of a link or activation of the link plus a specific transaction, the specific transaction including purchase of a specific merchandise, purchases totaling a specific dollar amount, subscription, purchase of a service, and membership to certain groups.
